(19) United States
(12) Patent Application Publication
(10) Pub. No.: US 2026/0356010 A1
(43) Pub. Date: Nov. 12, 2026

(54) APPARATUS FOR PRODUCING SYNTHETIC THREADS FROM RECYCLED PLASTIC WASTE

(71) Applicant: BB Engineering GmbH, Remscheid (DE)

(72) Inventors: Klaus Schäfer, Remscheid (DE); Ralf Morgenroth, Wuppertal (DE)

(21) Appl. No.: 19/122,022

(22) PCT Filed: Oct. 11, 2023
(86) PCT No.: PCT/EP2023/078155

§ 371 Date: Apr. 17, 2025

(30) Foreign Application Priority Data
Oct. 18, 2022 (DE) 10 2022 003 870.6

(51) Int. Cl. B29B 17/00; B29K 67/00; B29K 105/26; D01D 5/08; D01F 6/62; D02G 3/02

(52) U.S. Cl. CPC B29B 17/0026; D01D 5/08; D01F 6/62; D02G 3/02; B29B 2017/001; B29K 2067/003; B29K 2105/26; D10B 2331/04

(57) ABSTRACT

An apparatus for producing synthetic threads from recycled plastic waste includes a pre-treatment device for pre-treating textile plastic waste; a melting device for melting pre-treated plastic waste to form a plastic melt; and a spinning device for extruding threads from a plastic melt produced by the melting device.

The present invention relates to an apparatus for producing synthetic threads from recycled plastic waste. The present invention likewise relates to the use of such an apparatus, and to a method for producing synthetic threads from recycled plastic waste.

The recycling of material for recovering plastic materials, for example from so-called PET bottles, is becoming increasingly important. Described in the prior art are methods for recycling plastic materials, according to which methods a recycling material is melted and the plastic melt is subsequently filtered and degassed, so as to obtain an ideally pure polymer melt for re-use.

A method and an apparatus for recycling plastic materials are disclosed in WO 2020/104432A1, for example. According to this prior art, a recycling material in the form of PET flakes is fed to the respective apparatus and melted in a melting extruder. Consequently, such an apparatus is conceived to be fed PET flakes, and the possibilities for recovering plastic materials are thus limited. Other forms or types of plastic waste material cannot be readily treated in an apparatus shown in WO 2020/104432A1.

The processing of recyclable material into so-called PET flakes is well known and widely used in the industry. However, the processing in order to form such PET flakes is time-consuming and cost-intensive. Furthermore, the processing of plastic waste fibers is also complex and requires a separate pre-treatment so as to then be able to process granules in synthetic spinning plants in order to form plastic threads. The devices used in the known recycling plants such as published in WO 2020/104432A1, for example, are typically insufficient for handling waste fibers and for adding the latter to a recycling material.

Against the background set forth above, the object of the present invention was to specify an apparatus for producing synthetic threads, which can be operated with an improved resource efficiency and/or a greater flexibility in terms of the characteristics of fed plastic waste. Furthermore, the object was to specify the use of such an apparatus, as well as a method for producing synthetic threads from recycled plastic waste.

In terms of the apparatus, this object has been achieved by the subject matter of claim 1. The use according to the invention is set forth in claim 16, and a method according to the invention is set forth in claim 17. Advantageous design embodiments are the subject matter of the respective dependent claims and will be explained hereunder.

According to a first aspect of the invention, an apparatus according to the invention for producing synthetic threads is equipped with a pre-treatment device for pre-treating textile plastic waste, with a melting device for melting pre-treated plastic waste so as to form a plastic melt, and with a spinning device for extruding threads from a plastic melt generated by the melting device.

As a result of the pre-treatment, the melting and the subsequent extrusion or spinning of the spun threads, synthetic waste threads or else plastic textiles and production waste can be supplied for recycling in a particularly simple and cost-effective way, in order to produce new synthetic threads. Particularly advantageously, mixtures of fiber, textile, film and/or bottle waste can also be processed.

Synthetic threads for the production of which an apparatus according to the invention can be designed can consist, for example, of polyester, in particular of polyethylene terephthalate (PET), and, for example, according to their characteristics can be classified, inter alia, in the following categories: POY (partially oriented yarn); FDY (fully drawn yarn), IDY (industrial yarn); SF (staple fiber); PSF (polyester staple fiber); BCF (bulk continuous filament). Consequently, the pre-treatment device provided according to the invention can be specified for pre-treating textile plastic waste of polyester, in particular of polyethylene terephthalate (PET).

In the context of the present invention, textile plastic waste can in particular be threads, yarns, fabrics, woven fabrics, films and/or textile planar structures and/or film-type planar structures. In this way, the pre-treatment device provided according to the invention can guarantee a broad spectrum for recycling different types and forms of plastic waste.

According to a preferred design embodiment it can be provided that the pre-treatment device is disposed upstream of the melting device. As a result, a direct feed into the melting device can advantageously be achieved, and an overall compact construction of the apparatus is guaranteed.

Furthermore, it can be additionally or alternatively provided that the pre-treatment device is designed for mechanically pre-treating textile plastic waste. As a result of a mechanical pre-treatment, the shapes of the plastic waste that are undesirable for further processing can advantageously be changed or adapted to the subsequent melting process. An overall compact construction can be implemented in this way, and the energy consumption of the overall process, or of the apparatus, can be reduced.

Moreover, according to a preferred design embodiment it can be additionally or alternatively provided that the pre-treatment device is designed for pre-treating threads, yarns, fabrics, woven fabrics, films and/or textile planar structures and/or textile plastic waste of polyethylene terephthalate (PET). This enables a specific design embodiment of the apparatus for the production of new threads of PET. Alternatively, the pre-treatment device can also be designed to pre-treat polymers in general, or all types of polymers, the flexibility in terms of use being improved as a result.

According to a further advantageous design embodiment, the pre-treatment device has a plurality of treatment apparatuses, in particular for carrying out a plurality of sequential pre-treatment steps for textile plastic waste. As a result, the particle size, the granularity, the water content and/or the density of the pre-treated material can easily be influenced in a targeted manner. Treatment apparatuses can be, for example, a comminution apparatus, a pre-drying device and/or a compacting apparatus. The comminuted plastic waste is only compacted by the compacting apparatus, but no agglutinating or agglomeration takes place. This means that no additional heat is introduced, which enables melting and/or adhesive bonding of the comminuted textile plastic waste.

According to a particularly preferred design embodiment, it can be provided that the pre-treatment device has at least one comminution apparatus, in particular a granulator, for mechanically comminuting textile plastic waste. As a result, the material to be pre-treated can advantageously be processed to form granules, powder, small particles and/or short thread portions and/or small textile portions, which can be particularly advantageously processed downstream. In particular, fibers, non-wovens and/or filaments of textile plastic waste are converted into synthetic filaments and/or fibers are converted into fibers, non-wovens and/or filaments in a single-stage method. This is advantageously facilitated by the compacting apparatus which avoids that the plastic waste batches melt conjointly.

According to a preferred refinement, the pre-treatment device has at least one pre-drying apparatus for pre-drying and/or homogenizing the material moisture of textile plastic waste, in particular of comminuted textile plastic waste. Such a pre-drying apparatus can preferably be disposed downstream of the comminution apparatus. As a result of the pre-drying of the material, which emanates in particular from the comminution apparatus, captive liquids are evaporated and/or discharged so that the dried material can be imparted a further improved suitability for further processing.

A disposal of the pre-drying apparatus downstream of the comminution apparatus enables particularly advantageous drying, because comminuted material has a larger surface, thus allowing liquid to be more rapidly extracted. Moreover, there is the possibility that the drying procedure is adapted to the requirements of the comminuted material. Any adaptation can be performed once or continuously.

Moreover, according to an advantageous refinement, the pre-treatment device can have at least one compacting apparatus for compacting textile plastic waste. As a result, the density and/or the volume of the materials to be recycled can be advantageously set for further processing. Such compacting can particularly advantageously be performed with the view to the infeed into a melting extruder, so that suitable melting without local temperature peaks can for the first time take place in the melting extruder. No melting takes place during compaction. The compaction takes place below the melting temperature of the plastic waste to be recycled.

In such a compaction, comminuted and/or pre-dried textile plastic waste can in particular be compacted. As a result, textile and/or fibrous material which has already been suitably pre-treated is supplied to the melting device, this being particularly advantageous for the recycling process and the production of synthetic fibers subsequent to melting. The compaction apparatus here can preferably be disposed downstream of the pre-drying apparatus. This results in a particularly advantageous process sequence.

According to a further advantageous design embodiment, the compaction apparatus can be designed as a screw compactor. As a result, a constant volumetric flow can advantageously be dispensed to a subsequent apparatus station. This is advantageous in particular when the compaction apparatus is disposed so as to feed textile plastic waste directly into the melting device. A melting device which is supplied with a constant volumetric flow can be operated in a particularly advantageous manner, in particular with comparatively minor temperature gradients within the material to be recycled. Furthermore, replenishing the subsequent apparatus stations, in particular the melting device, which interrupts the recycling and production process, can be avoided in this way.

In a further preferred design embodiment, the melting apparatus can be designed as a melting extruder. A melting extruder enables a continuous delivery of material, so that plastic melts for producing fibers can be particularly advantageously prepared as a result. The melting extruder can particularly advantageously be designed as a single-shaft or a multiple-shaft melting extruder and/or vacuum melting extruder, so that a greater and/or more homogenized volumetric flow can advantageously be generated.

Furthermore, according to a preferred design embodiment, the apparatus can have at least one filter device for filtering a plastic melt and/or for multi-stage filtering a plastic melt. A high level of purity in the plastic melt can be generated by the filtration, or by a multi-stage filtration, respectively.

Initially, coarse solid particles and contaminants can be removed from the molten recycling material by way of a first filtration of the plastic melt, in particular in a positive-pressure atmosphere. A subsequent second filtration, for example with integrated degassing, can be embodied in a correspondingly fine manner, so as to initially remove the solid matter prior to actual degassing. As a result, the plastic melt can be homogenized to a high degree, so that the latter can subsequently be discharged directly to final processing.

The filtered plastic melt can be directly degassed by filtration in a negative-pressure atmosphere. In this way, contact zones of a comparatively large area between the plastic melt and the negative-pressure atmosphere can be implemented, and the volatile constituent parts can be released from the plastic melt in a relatively short dwell time.

Furthermore, the apparatus according to the invention can have at least one melt pump for conveying a plastic melt. Suitable conveying of the plastic melt within the apparatus is enabled in this way.

The filter device, in particular a first filter device and/order second filter device, and/or the melt pump can preferably be disposed between the melting device and the spinning device. The filtration of a melt provided by the melting device increases the degree of purity of the melt for later process steps, and consequently enables the production of high-quality fibers.

Moreover, according to a further design embodiment of the apparatus, at least one degassing device for degassing a plastic melt can be provided, wherein the degassing device can preferably be disposed between the melting device and the spinning device, in particular between the melt pump and the spinning device. This can reduce the formation of bubbles, or gas pockets, in the melt and further improve the purity of the melt, so that a high quality of the final products from the spinning device can be ensured.

Such a degassing device can particularly preferably be a second filter device which is disposed downstream of a first filter device.

Additionally, it can be provided that the degassing device is designed to filter and/or decontaminate a plastic melt and/or to degas a plastic melt by means of a vacuum, in particular a high vacuum of 1 to 50 mbar. Due to the low pressure, gases within the plastic melt can be particularly favorably removed or discharged. Furthermore, a filtration in the degassing device can be carried out in addition to further filtrations in filter devices of the apparatus. As a result, contaminants in the plastic melt can be particularly reliably removed.

Finally, in an advantageous refinement, the degassing device can be designed to increase an intrinsic viscosity of the plastic melt of up to 0.15 dl/g, and/or to homogenize the viscosity and/or to generate a spinning-capable plastic melt. The IV value for the melt spinning of the final product can be particularly favorably influenced by homogenizing the viscosity of the degassed plastic melt, in particular up to a value of 0.15 dl/g, so that a high quality of the produced threads can be ensured. Due to the production of a spinning-capable plastic melt in the degassing device, the apparatus for producing the synthetic fibers can particularly advantageously be constructed in a compact and cost-effective manner.

If the viscosity is to be further increased, the apparatus, according to a further advantageous design embodiment, can have a dwell reactor for receiving a pre-filtered and/or degassed plastic melt.

A dwell reactor can preferably have a driven worm shaft for conveying the plastic melt, and/or be disposed downstream of the degassing device. A dwell reactor having a driven worm shaft is also referred to as a disc ring reactor. A dwell reactor, or a disc ring reactor, apart from generating a high viscosity, also advantageously allows a further homogenization of the plastic melt. A worm shaft is particularly suitable for further homogenization, because the worm shaft improves mixing of the plastic melt and can convey the latter at a largely constant rate and thus uniformly.

According to a further advantageous design embodiment, it can be provided that the dwell reactor is designed to increase the intrinsic viscosity of the received plastic melt. Additionally or alternatively, the dwell reactor can be designed to generate a spinning-capable plastic melt. In this way, the plastic melt can be adapted for use in a downstream spinning device. Particularly preferably, the dwell reactor can be designed to increase the intrinsic viscosity up to 1.1 dl/g. In this way, quality fibers, or particularly durable plastic fibers, can be produced from plastic waste.

A dwell reactor can be advantageous in particular when BCF and/or IDY threads are produced in the downstream spinning device, or the spinning device is designed and/or specified for producing BCF and/or IDY threads.

Furthermore preferably, the apparatus can have a discharge extruder for discharging a plastic melt to the spinning device. Additionally or alternatively, the apparatus can have a discharge pump for discharging a plastic melt to the spinning device. A discharge extruder and/or a discharge pump can preferably be disposed downstream of the degassing device and/or the dwell reactor, and/or have a final filter device. A discharge extruder is able to supply a constant volumetric flow of a prepared plastic melt to a downstream spinning device, or to a downstream final filter device. In this way, a further homogenized melt can particularly advantageously be provided for the melt spinning of plastic fibers. The process pressure for the melt spinning can be reliably ensured by providing a discharge pump.

A further aspect of the present invention relates to the use of an apparatus described above for producing synthetic threads from textile plastic waste, in particular for producing POY, FDY, BCF, PSF and/or IDY threads from textile plastic waste.

Yet a further aspect of the present invention relates to a method for producing synthetic threads from recycled plastic waste, in particular using an apparatus described above, in which method textile plastic waste is pre-treated in a pre-treatment device, in which method the pre-treated plastic waste is melted by a melting device so as to form a plastic melt, and in which method synthetic threads are extruded from the generated plastic melt by a spinning device. The plastic waste is converted into a synthetic filament and/or fiber in a single-stage process without intermediate products. There is no clumping, adhesive bonding and/or melting upon compaction of the plastic waste. Compaction takes place far below the melting temperature of the respective plastic waste.

As a result of these steps according to the invention, the production of plastic fibers from recycling material containing textile plastic materials is in particular made possible. The resource efficiency in the production of synthetic fibers can be improved with only little complexity in this way.

A further independent aspect of the present invention relates to an apparatus for recycling plastic materials, having a pre-treatment device for pre-treating textile plastic waste, in particular a pre-treatment device described above, having a melting device for melting pre-treated plastic waste so as to form a plastic melt, in particular a melting device described above, and having a processing device for producing a product from a plastic melt generated by the melting device. According to the above explanations, the processing device can be a spinning device for melt-spinning synthetic threads, or else other types of processing devices, in particular for generating other intermediate products and/or final products.

According to an advantageous design embodiment, the processing device can be designed as a final processing device for producing a final product and/or as an intermediate processing device for producing an intermediate product. An intermediate processing device can be followed by additional processing apparatuses, other apparatuses for recycling plastic materials, or other processing machines.

According to a further design embodiment, it can be provided that the processing device is designed as a granulating apparatus for generating plastic granules. Plastic granules can advantageously be used for downstream processing so as to form a multiplicity of different products.

The above-described method for producing synthetic threads is particularly preferably a melt-spinning method, in particular for producing melt-spun threads from a plurality of filaments.

The preferred design embodiments and advantages described above in terms of the apparatus for producing synthetic threads from recycled plastic waste apply in an analogous manner also to the method for producing synthetic threads, and also to the above-described use of an apparatus according to the invention.

The invention will be described by way of example hereunder with reference to the appended FIGURE in which, schematically:

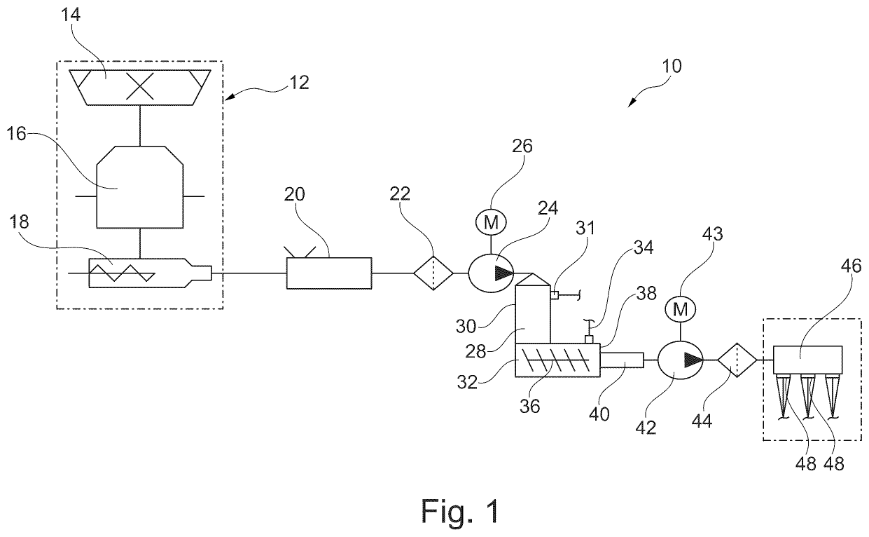

FIG. 1 shows an apparatus for producing synthetic threads from recycled plastic waste, according to an exemplary embodiment of the present invention.

Schematically illustrated in FIG. 1 is an exemplary embodiment of an apparatus 10 according to the invention for producing synthetic threads from recycled plastic waste. The apparatus 10 has a pre-treatment device 12 having a comminution apparatus 14, a pre-drying device 16 as well as a compacting apparatus 18. The pre-drying device 16 is disposed downstream of, or after, the comminution apparatus 14. The compacting apparatus 18 is disposed downstream of, or after, the pre-drying device 16.

The apparatus 10 furthermore has a melting device 20. The melting device 20 can be disposed downstream of, or after, the compacting apparatus 18. The melting device 20 can be designed as a melting extruder. The melting device 20 can be embodied with one or a plurality of shafts and be connected to a filter device 22 by way of an extruder outlet, wherein the melting device 20 optimally has a vacuum-based degassing unit.

Following downstream of, or after, the filter device 22 is a melt pump 24 which is driven by way of a pump drive 26. A plastic melt can be suitably conveyed by the melt pump 24.

The melt pump 24 is connected to a degassing device 28. The degassing device 28 has a housing 30 which is formed, for example, by a cylindrical pot having a cover. A vacuum chamber in which a plurality of filter elements, not illustrated in more detail here, in the form of hollow-cylindrical filter cartridges can be disposed can be formed within the housing 30. Filter elements of this kind possess a permeable filter wall and guarantee further filtration of the plastic melt. The vacuum chamber in the housing 30 can be connected to a collection container, not shown here, and to a vacuum pump, likewise not illustrated in more detail here, by way of a vacuum connector 31.

The degassing device 28 can be coupled to a dwell reactor 32. The degassing device 28, on an outlet side in a base region of the housing 30, can be connected to the dwell reactor 32. A filtered and degassed plastic melt from the degassing device 28 can be supplied directly to an inlet region of the dwell reactor 32.

The dwell reactor 32 can have on its outlet side a vacuum connector 34. The vacuum connector 34 can be connected to a separate vacuum pump. A driven worm shaft 36 which feeds the plastic melt to a reactor outlet 38 can be disposed within the dwell reactor 32.

A discharge extruder 40 for discharging the filtered and degassed plastic melt can be provided on the reactor outlet 38.

In turn, a discharge pump 42 having a pump drive 43, and furthermore a final filter device 44, can be disposed downstream of the discharge extruder 40.

As a final processing apparatus, the apparatus 10 furthermore has a spinning device 46 for extruding threads from a plastic melt generated by the melting device 20. The spinning device 46 can have a plurality of spinnerets 48 for extruding synthetic threads. The final filter device 44 can be disposed upstream of the spinning device 46.

In the exemplary embodiment illustrated in FIG. 1, the degassing and homogenization of the plastic melt by the dwell reactor 32 can still be intensified. In this way, additional gases released from the plastic melt can be removed by way of the vacuum connector 34. Such an apparatus 10 having the dwell reactor 34 illustrated is particularly suitable for carrying out direct final processing of the recycled plastic material so as to form new synthetic threads.

In the operation of the apparatus 10, a material to be recycled, for example plastic thread waste, can be supplied to the pre-treatment device 12, in particular to the comminution apparatus 14 designed as a granulator. In the latter, a comminution is performed in order for the recycled material to be reused. As a result of the cutting, separating and/or grinding in the comminution apparatus 14, a fine-grain bulk material, granules and/or powder is/are generated, the latter however still having the molecular characteristics of the original material.

The comminuted recycled material is in a next step supplied to the pre-drying device 16 and heated, as a result of which the moisture in the granule material is removed and the latter is homogenized. This achieves a homogenization of the material moisture within the material.

Finally, in a further step of the pre-treatment, the dried recycling material is supplied to the compacting apparatus 18, which is designed as a screw compactor, and compressed so that a compacted or compressed mass is obtained as a recycling material which can be fed into the melting device 20 disposed downstream, the latter here being designed as a melting extruder.

The recycling material which has been prepared as described above can be supplied to the melting unit 20, which is designed as a melting extruder, directly from the compacting apparatus 18. The melting extruder here can preferably be designed without a vacuum unit. However, this melting extruder may also be embodied with a vacuum unit.

The melting unit 20 heats the recycling material at least up to the melting point of the latter, thus generating a plastic melt which is supplied to the adjoining filter device 22 by way of the extruder outlet. In the filter device 22, the plastic melt is first pre-filtered using a comparatively course filter fineness, in order to remove foreign particles such as remnants of paint, lacquer or decals, or else contaminants, as well as particles of the recycling material that have not melted from the plastic melt. The filtration of the plastic melt here can take place in a positive-pressure atmosphere. The pre-filtered plastic melt is received by the melt pump 24 and supplied to the degassing device 28 at an adjustable and ideally constant operating pressure.

The plastic melt makes its way via a melt inlet into a pressure chamber of the degassing device 28 and penetrates filter elements disposed therein. In order to generate the vacuum in the vacuum chamber of the degassing device 28, a vacuum pump which by way of the vacuum connector 31 is connected to the degassing device 28 is provided.

The gases which evaporate from the plastic melt due to the negative-pressure atmosphere, and volatilizing constituent parts, can be discharged from the vacuum chamber of the degassing device 28 by way of the vacuum connector 31, and be collected in a collection container not shown here. The plastic melt degassed in such a manner accumulates on the base of the housing and leaves the degassing device 28 by way of a melt outlet on the base of the housing 30.

From the melt outlet of the degassing device 28, the degassed and filtered plastic melt makes its way directly or indirectly into the discharge extruder 40. In the present exemplary embodiment, the dwell reactor 32 is additionally provided between the degassing device 28 and the discharge extruder 40. In this context, a filtered and degassed plastic melt is supplied from the degassing device 28 to an inlet region of the dwell reactor 10 and is directed through the reactor outlet 38 into the discharge extruder 40.

An apparatus 10 according to the present invention particularly advantageously enables the recycling of textile plastic waste for producing new synthetic threads. Production can take place in a particularly resource-friendly manner, and the recycling or preparation of textile plastic waste is ensured.

### LIST OF REFERENCE SIGNS

10 Apparatus for producing synthetic threads
12 Pre-treatment device
14 Comminution apparatus
16 Pre-drying apparatus
18 Compacting apparatus
20 Melting device
22 Filter device
24 Melt pump
26 Melt pump drive
28 Degassing device
30 Housing
31 Vacuum connector
32 Dwell reactor
34 Vacuum connector
36 Worm shaft
38 Reactor outlet
40 Discharge extruder
42 Discharge pump
43 Pump drive
44 Final filter device
46 Spinning device
48 Spinnerets

1. An apparatus for producing synthetic threads from recycled plastic waste, comprising:
a pre-treatment device for pre-treating textile plastic waste;
a melting device for melting pre-treated plastic waste so as to form a plastic melt; and
a spinning device for extruding threads from the plastic melt generated by the melting device.

2. The apparatus as claimed in claim 1, wherein the pre-treatment device is disposed upstream of the melting device, and/or the pre-treatment device is constructed and arranged to mechanically pre-treat textile plastic waste, and/or the pre-treatment device is constructed and arranged to pre-treat threads, yarns, fabrics, woven fabrics, films and/or textile planar structures and/or textile plastic waste of polyethylene terephthalate.

3. The apparatus as claimed in claim 1, wherein the pre-treatment device has a plurality of treatment apparatuses for carrying out a plurality of sequential pre-treatment steps for textile plastic waste.

4. The apparatus as claimed in claim 3, wherein the pre-treatment device has at least one comminution apparatus including a granulator, for mechanically comminuting textile plastic waste.

5. The apparatus as claimed in claim 3, wherein the pre-treatment device has at least one pre-drying apparatus for pre-drying and/or homogenizing the moisture of comminuted textile plastic waste, wherein the pre-drying apparatus is disposed downstream of the comminution apparatus.

6. The apparatus as claimed in claim 3, wherein the pre-treatment device has at least one compacting apparatus for compacting comminuted and/or pre-dried textile plastic waste, wherein melting of the textile plastic waste does not take place during comminution, and/or wherein the compacting apparatus is disposed downstream of the pre-drying apparatus.

7. The apparatus as claimed in claim 6, wherein the compacting apparatus is a screw compactor, and/or is disposed to feed textile plastic waste directly into the melting device.

8. The apparatus as claimed in claim 1, wherein the melting device is a single-shaft or multiple-shaft melting extruder and/or vacuum melting extruder.

9. The apparatus as claimed in claim 1, further comprising:
at least one filter device for filtering a plastic melt and/or for multi-stage filtering a plastic melt, and/or at least one melt pump for conveying a plastic melt, wherein the filter device and/or the melt pump are/is disposed between the melting device and the spinning device.

10. The apparatus as claimed in claim 9, further comprising:
at least one degassing device for degassing a plastic melt, wherein the degassing device is disposed between the melting device and the spinning device, in particular between the melt pump and the spinning device.

11. The apparatus as claimed in claim 10, wherein the degassing device is constructed and arranged to filter and/or decontaminate a plastic melt, and/or to degas a plastic melt by means of a a high vacuum of 1 to 50 mbar.

12. The apparatus as claimed in claim 10, wherein the degassing device is constructed and arranged to increase an intrinsic viscosity of the plastic melt of up to 0.15 dl/g, and/or to homogenize the viscosity and/or to generate a spinning-capable plastic melt.

13. The apparatus as claimed in claim 10, further comprising:
a dwell reactor for receiving a pre-filtered and/or degassed plastic melt, wherein the dwell reactor preferably has a driven worm shaft for conveying the plastic melt, and/or is disposed downstream of the degassing device.

14. The apparatus as claimed in claim 13, wherein the dwell reactor is constructed and arranged to increase the intrinsic viscosity of a received plastic melt, and/or to generate a spinning-capable plastic melt, and/or to increase the intrinsic viscosity up to 1.1 dl/g.

15. The apparatus as claimed in claim 13, further comprising:
a discharge extruder for discharging a plastic melt, and/or a discharge pump for discharging a plastic melt to the spinning device, wherein the discharge extruder and/or the discharge pump are/is disposed downstream of the degassing device and/or of the dwell reactor and/or have/has a final filter device, and/or a final filter device is disposed downstream of the discharge extruder and/or of the discharge pump.

16. The apparatus as claimed in claim 1, wherein the synthetic threads are partially oriented yarn (POY), fully drawn yarn (FDY), bulk continuous filament (BCF), polyester staple fiber (PSF) and/or industrial yarn (IDY) threads produced from textile plastic waste.

17. A method for producing synthetic threads from recycled plastic waste using an apparatus which includes a pre-treatment device for pre-treating textile plastic waste, a melting device for melting pre-treated plastic waste so as to form a plastic melt, and a spinning device for extruding threads from the plastic melt generated by the melting device,
in which method textile plastic waste is pre-treated in the pre-treatment device;
in which method the pre-treated plastic waste is melted by the melting device so as to form a plastic melt; and
in which method synthetic threads are extruded from the generated plastic melt by the spinning device, wherein the plastic waste is converted into a synthetic filament and/or fiber in a single-stage process without intermediate products.
